(19) United States
(12) Patent Application Publication
(10) Pub. No.: US 2016/0127086 A1
(43) Pub. Date: May 5, 2016

(54) METHOD AND APPARATUS FOR TRANSMITTING SIGNAL

(71) Applicant: Electronics and Telecommunications Research Institute, Daejeon (KR)

(72) Inventors: Eun-Young CHOI, Daejeon (KR); Seung Eun HONG, Daejeon (KR); Il Gyu KIM, Okcheon-gun Chungcheongbuk-do (KR); Seung Chan BANG, Daejeon (KR)

(21) Appl. No.: 14/926,635

(22) Filed: Oct. 29, 2015

(30) Foreign Application Priority Data
Oct. 29, 2014 (KR) 10-2014-0148689

(51) Int. Cl. H04L 5/00; H04W 36/00; H04W 52/32; H04W 72/04

(52) U.S. Cl. CPC H04L 5/0007; H04W 72/0473; H04W 72/042; H04W 36/0072; H04W 52/325

(57) ABSTRACT

A method and apparatus for transmitting a signal to a terminal are provided. The method includes: determining at least one of a plurality of resource blocks (RBs) of a frequency resource and a time resource in a subframe that transmits to the terminal; allocating a power rate to each of a first signal and a second signal to transmit to the terminal; and transmitting the first signal and the second signal through the RB according to the allocated power rate.

### CROSS-REFERENCE TO RELATED APPLICATION

This application claims priority to and the benefit of Korean Patent Application No. 10-2014-0148689 filed in the Korean Intellectual Property Office on Oct. 29, 2014, the entire contents of which are incorporated herein by reference.

### BACKGROUND OF THE INVENTION

(a) Field of the Invention

The present invention relates to a method and apparatus for simultaneously transmitting a signal including different kinds of information to a terminal.

(b) Description of the Related Art

A channel of a communication system may be divided into a control channel and a traffic channel according to a property of transmitted data. For example, in a long term evolution (LTE) system, a physical channel includes a physical downlink shared channel (PDSCH), a physical broadcast channel (PBCH), a physical multicast channel (PMCH), a physical downlink control channel (PDCCH), a physical H-ARQ indicator channel (PHICH), a physical control format indicator channel (PCFICH), a physical uplink shared channel (PUSCH), a physical uplink control channel (PUCCH), and a physical random access channel (PRACH). The PDSCH is a main physical channel for downlink unicast transmission. The PBCH is a physical channel for transmitting necessary system information when a terminal accesses a network. The PMCH is a channel for operating a multicast broadcast single frequency network (MBSFN). The PDCCH is a physical channel for transmitting scheduling approval for transmitting in the PUSCH and downlink control information such as scheduling information necessary for receiving the PDSCH. The PHICH is a physical channel notifying a terminal of retransmitting information. The PCFICH is a physical channel notifying information about a size of a PDCCH control area. The PUSCH is a main physical channel for transmitting uplink unicast. The PUCCH is a physical channel for transmitting notification of whether reception of a downlink transmitting block has succeeded, a channel state report, and an uplink scheduling request. The PRACH is a physical channel for random access of a terminal. For another example, a wireless local area network (WLAN) specification such as IEEE 802.11n/ac is divided into a signal field and a data field, information for restoring transmission data is loaded in the signal field, and a terminal restores a data field using information of the signal field.

As capacity increase of a communication system is required, a small cell concept was introduced. Further, in order to secure a wide frequency band, a millimeter wave (mmWave) frequency band was used. Further, while a beamforming concept is introduced, handover is frequently performed in a moving terminal, and while beam switching occurs, a control signal was frequently required according to beam switching. As the number of terminals increases and necessary predetermined information increases, a resource for a control signal necessary for data transmission is much required. That is, in modern mobile communication, a channel state quickly changes according to a moving speed or a communication environment, and as handover frequently occurs, much information should be continuously reported and thus while allocating much information to a control channel, overhead for a control signal increases.

### SUMMARY OF THE INVENTION

The present invention has been made in an effort to provide a method and apparatus having advantages of being capable of simultaneously transmitting control information and data to a terminal in order to effectively transfer a large amount of control information.

An exemplary embodiment of the present invention provides a method of transmitting a signal to a terminal. The method includes: determining at least one of a plurality of resource blocks (RBs) of a frequency resource and a time resource in a subframe that transmits to the terminal; allocating a power rate to each of a first signal and a second signal to transmit to the terminal; and transmitting the first signal and the second signal through the RB according to the power rate.

The first signal and the second signal may be signals including different kinds of information, and the first signal may be a control signal including control information about the terminal.

The first signal and the second signal may be signals including different kinds of information, and the first signal may be a data signal including data to transmit to the terminal.

The first signal may be a control signal including control information about the terminal, and the second signal may be a data signal including data to transmit to the terminal.

The determining of at least one may include determining an RB that is located at a time at which an RB in which a cell reference signal is transmitted does not exist.

The determining of at least one may include determining an RB that is located at a periphery of an RB in which a cell reference signal is transmitted.

The determining of at least one may include determining an RB in which data is transmitted.

The allocating of a power rate may include allocating a high power rate (HPR) to the first signal and allocating a low power rate (LPR) to the second signal.

The transmitting of the first signal may include modulating each of the first signal and the second signal to correspond to a modulation order.

The modulating of each of the first signal may include modulating each of the first signal and the second signal to correspond to a modulation order according to a quadrature phase shift keying (QPSK) method.

Another embodiment of the present invention provides an apparatus that transmits a signal to a terminal. The apparatus includes: a resource block (RB) determining processor that determines at least one of a plurality of RBs of a frequency resource and a time resource in a subframe that transmits to the terminal; a power rate allocation processor that allocates a power rate to each of a first signal and a second signal to transmit to the terminal; and a transmitter that transmits the first signal and the second signal through the RB according to the power rate.

The first signal and the second signal may be signals including different kinds of information, and the first signal may be a control signal including control information about the terminal.

The first signal and the second signal may be signals including different kinds of information, and the first signal may be a data signal including data to transmit to the terminal.

The first signal may be a control signal including control information about the terminal, and the second signal may be a data signal including data to transmit to the terminal.

The RB determining processor may determine an RB at a time at which an RB in which a cell reference signal is transmitted does not exist.

The RB determining processor may determine an RB that is located at a periphery of an RB in which a cell reference signal is transmitted.

The RB determining processor may determine an RB in which data is transmitted.

The power rate allocation processor may allocate a high power rate (HPR) to the first signal and allocate a low power rate (LPR) to the second signal.

The transmitter may modulate each of the first signal and the second signal to correspond to a modulation order

The transmitter may modulate each of the first signal and the second signal to correspond to a modulation order according to a quadrature phase shift keying (QPSK) method.

### BRIEF DESCRIPTION OF THE DRAWINGS

FIG. 1 is a diagram illustrating a transmitting apparatus according to an exemplary embodiment of the present invention.

FIG. 2 is a diagram illustrating a constellation of a transmitting signal according to an exemplary embodiment of the present invention.

FIGS. 3 and 4 are graphs illustrating performance of a receiving apparatus according to an exemplary embodiment of the present invention.

FIGS. 5 and 6 are diagrams illustrating a constellation of a transmitting apparatus according to another exemplary embodiment of the present invention.

FIG. 7 is a diagram illustrating a situation in which a terminal changes an access base station according to an exemplary embodiment of the present invention.

FIGS. 8 and 9 are diagrams illustrating a subframe of a mobile communication system.

FIG. 10 is a diagram illustrating a constellation of a power allocation method in which an HPR is allocated to PR_{C} according to an exemplary embodiment of the present invention.

FIG. 11 is a diagram illustrating a receiving apparatus according to an exemplary embodiment of the present invention.

FIG. 12 is a diagram illustrating a constellation of a power allocation method in which an LPR is allocated to PR_{C} according to an exemplary embodiment of the present invention.

FIG. 13 is a diagram illustrating a receiving apparatus according to another exemplary embodiment of the present invention.

FIG. 14 is a diagram illustrating a resource allocation apparatus according to an exemplary embodiment of the present invention.

FIGS. 15A and 15B are diagrams illustrating a resource allocation method according to an exemplary embodiment of the present invention.

FIG. 16 is a diagram illustrating an uplink resource allocation method according to an exemplary embodiment of the present invention.

FIGS. 17A and 17B are diagrams illustrating a resource allocation method according to another exemplary embodiment of the present invention.

FIGS. 18A and 18B are diagrams illustrating an uplink resource allocation method according to another exemplary embodiment of the present invention.

FIG. 19 is a diagram illustrating a resource allocation method of beam switching according to another exemplary embodiment of the present invention.

FIG. 20 is a block diagram illustrating a wireless communication system according to another exemplary embodiment of the present invention.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

In an entire specification, a mobile station (MS) may indicate a terminal, a mobile terminal (MT), an advanced mobile station (AMS), a high reliability mobile station (HR-MS), a subscriber station (SS), a portable subscriber station (PSS), an access terminal (AT), and user equipment (UE) and may include an entire function or a partial function of the MT, the MS, the AMS, the HR-MS, the SS, the PSS, the AT, and the UE.

Further, a base station (BS) may indicate an advanced base station (ABS), a high reliability base station (HR-BS), a node B, an evolved node B (eNodeB), an access point (AP), a radio access station (RAS), a base transceiver station (BTS), a mobile multihop relay (MMR)-BS, a relay station (RS) that performs a BS function, a relay node (RN) that performs a BS function, an advanced relay station (ARS) that performs a BS function, a high reliability relay station (HR-RS) that performs a BS function, and a small-sized BS [a femto BS, a home node B (HNB), a home eNodeB (HeNB), a pico BS, a metro BS, and a micro BS], and may include an entire function or a partial function of the ABS, the nodeB, the eNodeB, the AP, the RAS, the BTS, the MMR-BS, the RS, the RN, the ARS, the HR-RS, and the small-sized BS.

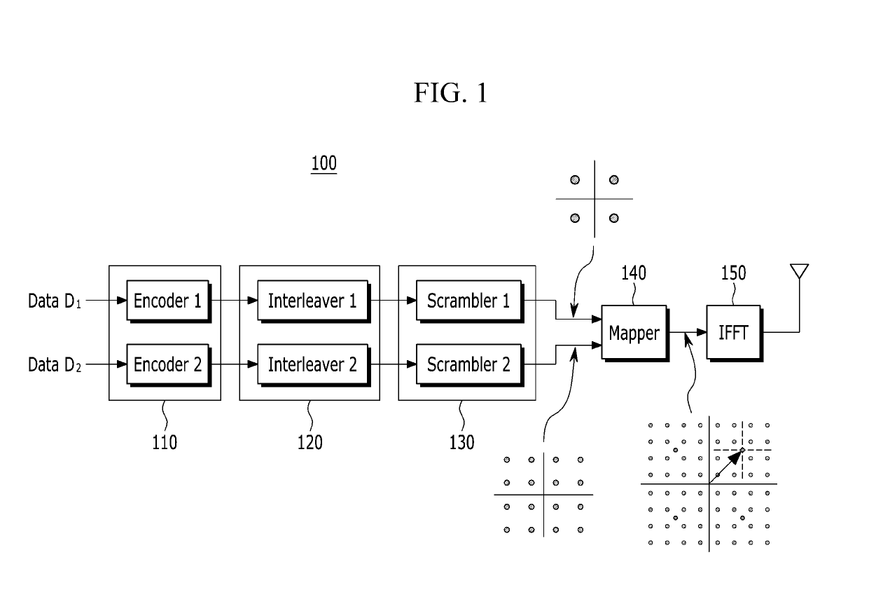

FIG. 1 is a diagram illustrating a transmitting apparatus according to an exemplary embodiment of the present invention.

Referring to FIG. 1, a transmitting apparatus 100 according to an exemplary embodiment of the present invention may include an encoder 110, an interleaver 120, a scrambler 130, a mapper 140, and an inverse fast Fourier transform (IFFT) unit 150.

In the transmitting apparatus 100, when data to simultaneously send are D₁, D₂, . . . , D_{N}, by passing through the encoder 110, the interleaver 120, and the scrambler 130, each data is encoded, interleaved, and scrambled. After each data is scrambled, in the mapper 140, each data is modulated to correspond to a modulation order that is allocated to the each data. Referring to FIG. 1, data D₂ modulated with 16 QAM) is mapped based on a constellation of data D₁ (modulated with QPSK). Thereafter, a mapped signal is converted and transmitted to a time domain through the IFFT unit 150.

In this case, a transmitting apparatus according to an exemplary embodiment of the present invention transmits two or more data using one resource and differently allocates a power rate to each data. Therefore, when total transmission power of a base station is 1, each data is transmitted with a power rate smaller than 1. When a power rate of each data is PR_{D1}, PR_{D2}, . . . , PR_{DN}, PR_{D1}+PR_{D2}+ . . . +PR_{DN}=1.

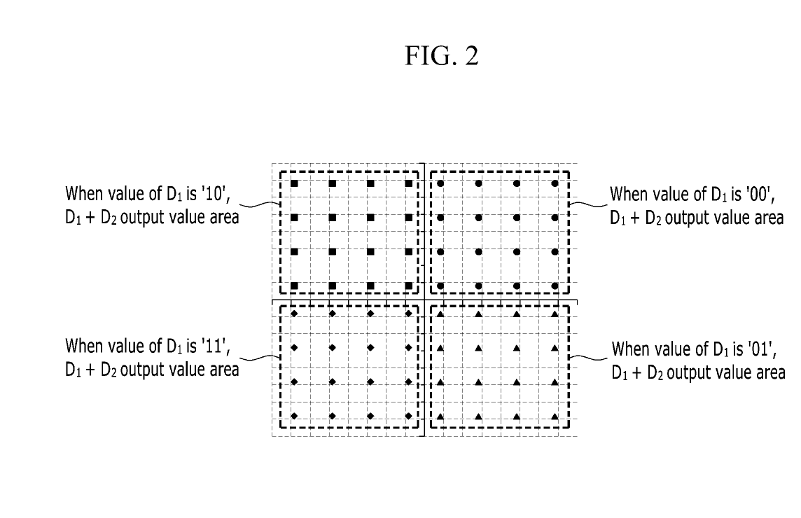

FIG. 2 is a diagram illustrating a constellation of a transmitting signal according to an exemplary embodiment of the present invention.

When a transmitting apparatus according to an exemplary embodiment of the present invention transmits two kinds of data, output constellations of the two kinds of data may be changed according to a power rate that is allocated to each data. For example, a transmitting signal in which the transmitting apparatus finally outputs may be expressed with the sum of two data, and when both D₁ and D₂ are modulated with a quadrature phase shift keying (QPSK) method, a transmitting signal has the same constellation as that of 16 Quadrature amplitude modulation (16 QAM). When D₁ is modulated with QPSK and when D₂ is modulated with 16 QAM, a transmitting signal has the same constellation as that of 64 QAM.

FIG. 2 illustrates a case in which a power rate that is allocated to D₁ is larger than a power rate that is allocated to D₂, and in which D₁ is modulated with QPSK and in which D₂ is modulated with 16 QAM. As shown in FIG. 2, a receiving apparatus, having received an output transmitting signal, may recognize that noise of D₂ is added to data of D₁. Further, in order to obtain data D₂, the receiving apparatus removes D₁ from a received signal and is demodulated and thus receiving performance of data D₂ may be deteriorated by an allocated power rate further than a case of transmitting with a power rate of 1.

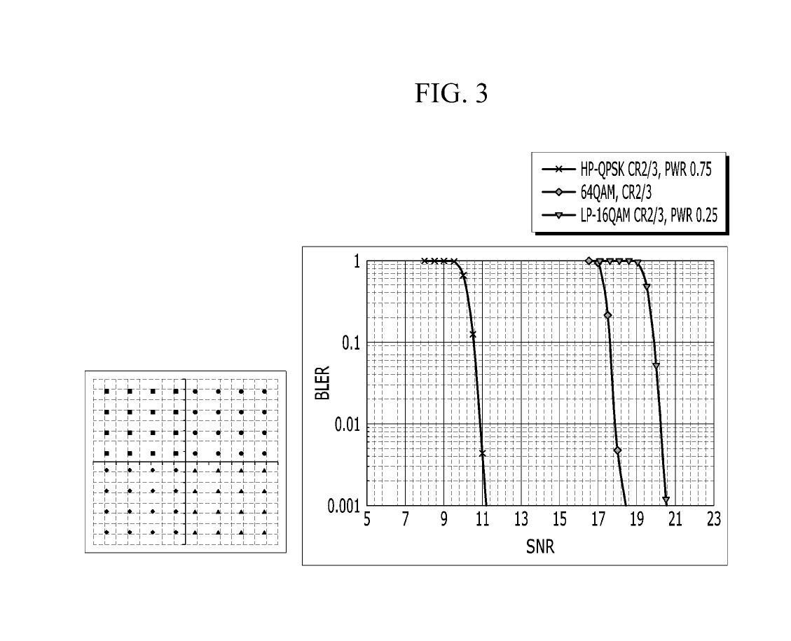

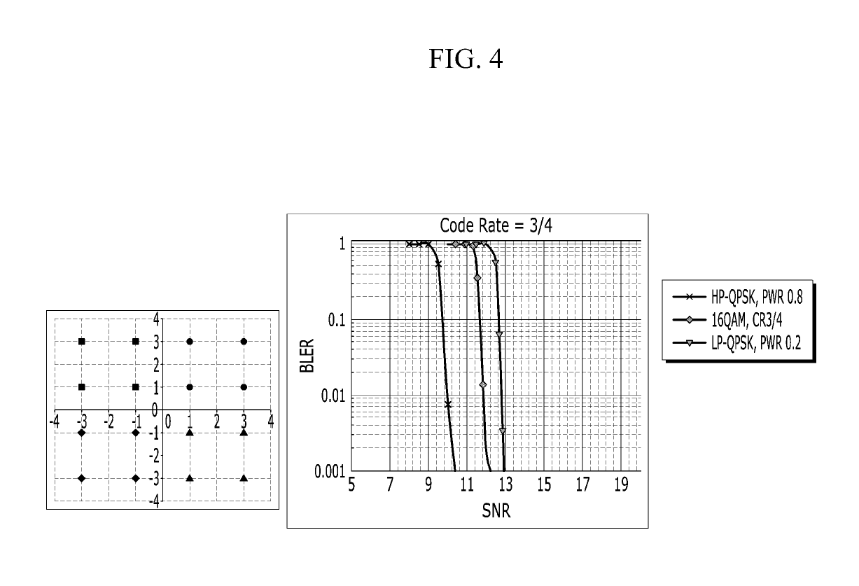

FIGS. 3 and 4 are graphs illustrating performance of a receiving apparatus according to an exemplary embodiment of the present invention.

In FIG. 3, two data are each modulated with QPSK and 16 QAM, and PR_{D1} is 0.75 and PR_{D2} is 0.25. When an output transmitting signal represents a 64 QAM form, which is an equal gap like the left side of FIG. 3, in data D₁, a determination area is widely formed and performance is thus improved, and in data D₂, data that may be detected with a high probability is reduced and thus performance is deteriorated, compared with a performance of existing 64 QAM.

In FIG. 4, both of the two data are modulated with QPSK, PR_{D1} is 0.8, and PR_{D2} is 0.2. When an output transmitting signal represents the 16 QAM form, which is an equal gap like the left side of FIG. 3, performance of data D₁ is improved and performance of data D₂ is deteriorated, compared with a performance of existing 16 QAM.

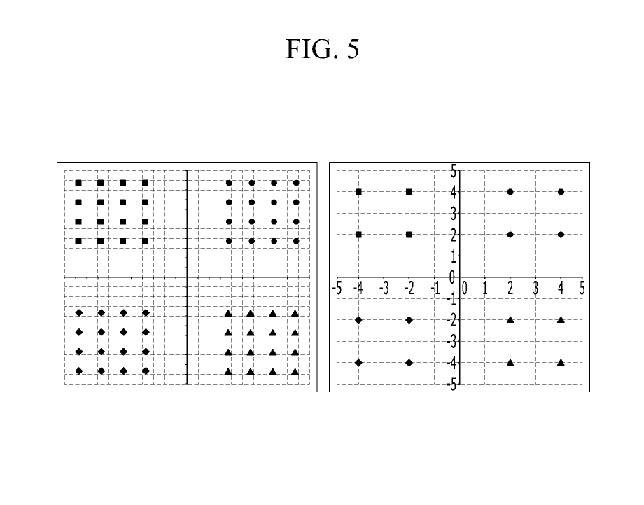

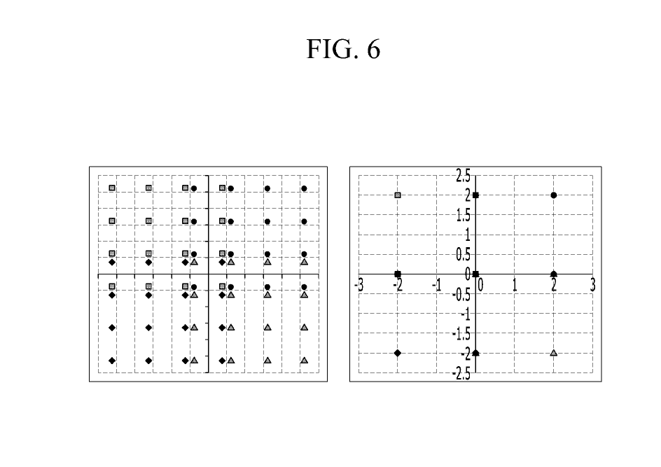

FIGS. 5 and 6 are diagrams illustrating a constellation of a transmitting apparatus according to another exemplary embodiment of the present invention.

In FIG. 5, in a power rate of two data, PR_{D1} is 0.9 and PR_{D2} is 0.1. Because a large power rate is allocated to data D₁ compared with data D₂, performance can be improved compared with when the allocated power rate is 0.75, but in data D₂, because a resolution between data is small, performance is largely deteriorated.

In FIG. 6, PR_{D1} is 0.5 and PR_{D2} is 0.5, and in this case, because an area of data D₁ is overlapped by data D₂, performance is largely deteriorated and thus it is difficult to demodulate in a receiving apparatus.

In a general communication system, in order to process transmitted and received data, a base station and a terminal send and receive much control information. Further, when a plurality of terminals access one base station, control information that the base station is to transfer to each terminal further increases.

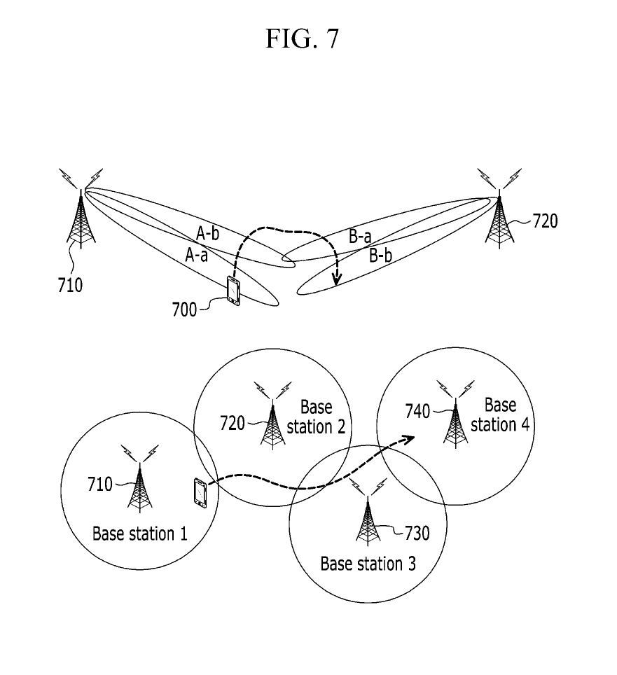

FIG. 7 is a diagram illustrating a situation in which a terminal changes an access base station according to an exemplary embodiment of the present invention.

Referring to an upper drawing of FIG. 7, when UE 700 moves at the inside of a cell of a base station 1, 710, the base station 1, 710 changes a beam transmitting to the UE 700 from A-a to A-b (beam switching). Thereafter, when the UE 700 changes an access base station from the base station 1, 710 to a base station 2, 720, the UE 700 receives a beam B-a from the base station 2, 720 (handover). Thereafter, when the UE 700 moves at the inside of a cell of the base station 2, 720, the base station 2, 720 transmits a beam B-b to the UE 700 (beam switching). In this case, when a width of a serviced beam is small or when a moving speed of the UE 700 is fast, beam switching and handover may frequently occur.

That is, in order for the moving UE 700 to smoothly communicate, even when the moving UE 700 moves at the inside of a cell of a base station as well as when the moving UE 700 moves to another base station, the moving UE 700 receives other beams, switches a beam, and performs handover according to a location from each base station. In this case, a control signal that the base station transmits to the UE 700 includes information about a cell and a beam.

Referring to a lower drawing of FIG. 7, the UE 700 moves from a cell of the base station 1, 710 to a cell of a base station 4, 740 by passing through a cell of the base station 2, 720 and a cell of a base station 3, 730. In this case, as a size of a cell of each base station is small, a handover process may be frequently performed and a handover process should be completed within a short time.

The following process is a handover process in LTE.

1. The UE 700 measures signal intensity of a peripheral cell and transfers the measured signal intensity to a source eNB, and the source eNB determines whether to perform handover of the UE.

2. The source eNB notifies a target eNB, which is a next eNB of the UE of handover, and generates a temporal tunnel to transmit data (divided into two according to a kind of a generated tunnel).
X2 handover: a temporal tunnel that directly connects a source eNB and a target eNB is generated.
S1 handover: each temporal tunnel is generated between a source eNB and a serving gateway (S-GW) and between a target eNB and an S-GW.

3. The UE accesses the target eNB, and downlink traffic is transmitted through the temporal tunnel.

4. Thereafter, the UE transmits and receives traffic and releases the temporal tunnel through the target eNB.

In order to successfully perform the handover process, the UE 700 should frequently measure a signal from a peripheral base station and frequently report to the source eNB. Further, as a message amount transmitting and receiving in the handover process increases, a necessary frequency resource may increase. Therefore, in an exemplary embodiment of the present invention, while allocating a time resource and a frequency resource necessary for transmitting a control signal, in order to also transmit a data signal therewith, the above-described power allocation method is used. A power allocation method according to another exemplary embodiment of the present invention can be applied even to a case in which transmission of much control information is requested, as the number of UEs 700 that a base station supports increases.

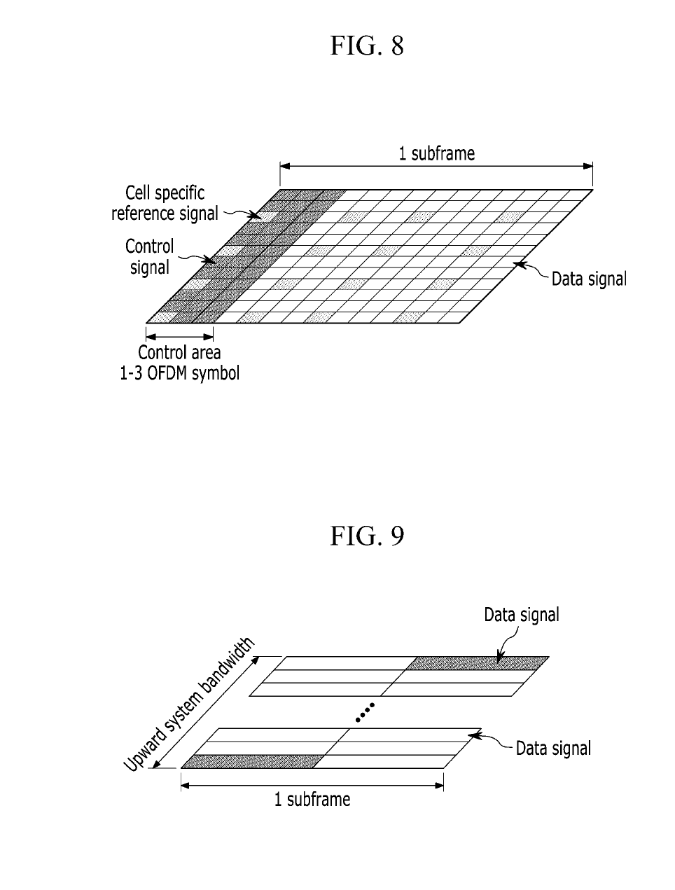

FIGS. 8 and 9 are diagrams illustrating a subframe of a mobile communication system.

Referring to FIG. 8, in a subframe, a control area occupies a resource of 20% or more of one subframe as 1-3 OFDM symbols. In this case, when the number of terminals in which a base station is to transmit data increases, overhead of a system may increase due to a resource that a control area occupies.

A control signal that is transferred to an uplink includes a HARQ ACK of a downlink transmitting block, a downlink channel state report, and a resource allocation scheduling request for transmitting the uplink. Referring to FIG. 9, such an uplink control signal is located at an edge of an uplink bandwidth.

When a terminal moves, if a downlink channel state report is frequently performed in each terminal, accuracy of handover increases, and thus when a channel state report of a downlink is together loaded in data that transmits to an uplink, a resource can be efficiently used to the maximum.

For example, when a resource of 20% is allocated to a control area, if one OFDM symbol is further additionally allocated for a control signal, overhead may increase by about 7%, but when a data signal and a control signal are simultaneously loaded in a corresponding OFDM symbol, a data signal that is modulated with at least QPSK may be further transmitted.

In an exemplary embodiment of the present invention, a control signal and a data signal may be transmitted together through one resource block using a power allocation method. When simultaneously transmitting a control signal C and a data signal D, a power rate (PR) is represented by Equation 1.

PR_{C}+PR_{D}=1 (Equation 1)

In this case, a power allocation method according to an exemplary embodiment of the present invention may be classified into a case in which PR_{C} is larger than PR_{D} and a case in which PR_{C} is smaller than PR_{D}. First, a case in which a high power rate (HPR) is allocated to PR_{C} will be described.

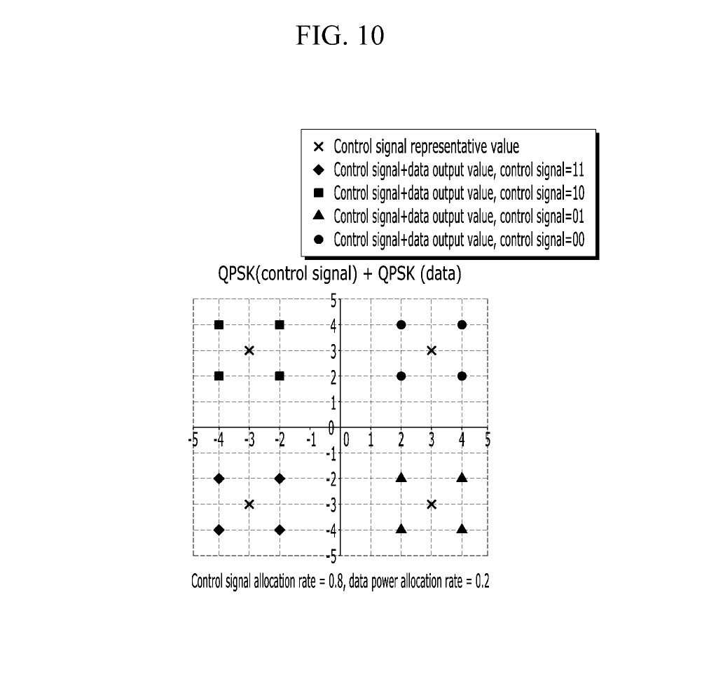

FIG. 10 is a diagram illustrating a constellation of a power allocation method in which an HPR is allocated to PR_{C} according to an exemplary embodiment of the present invention.

Referring to FIG. 10, modulation of control information and data is performed based on QPSK. Because an HPR (0.8) is allocated to control information, a control signal has better demodulation performance than that of a data signal in which a low power rate (LPR) of 0.2 is allocated. That is, in a receiving terminal, because a demodulation error probability of a control signal is lower than a demodulation error probability of a data signal, when the control signal is accurately demodulated, the data signal may also be normally restored.

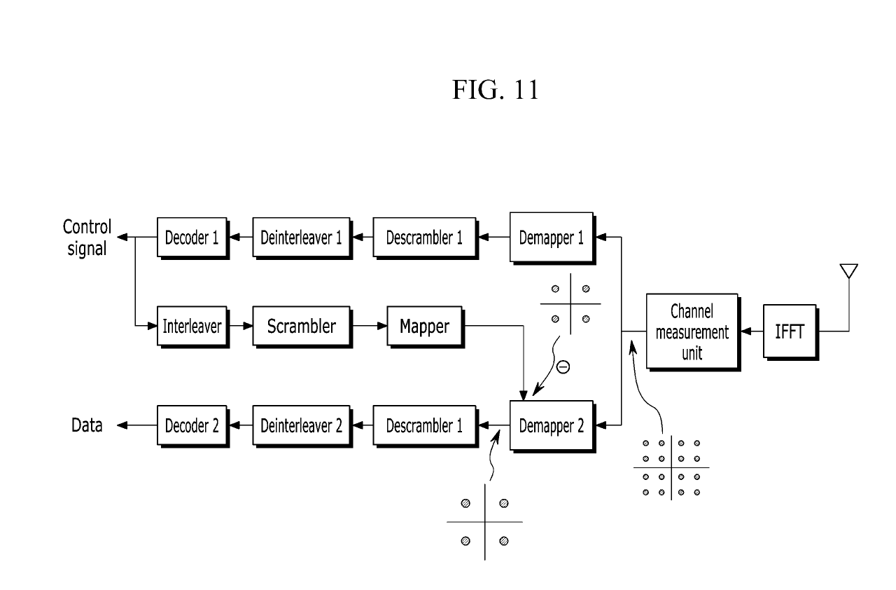

FIG. 11 is a diagram illustrating a receiving apparatus according to an exemplary embodiment of the present invention.

Referring to FIG. 11, when a QPSK control signal and a QPSK data signal are received, a demapper demodulates the control signal by demapping with QPSK and removes a demodulated control signal in a received signal. Thereafter, after again interleaving, scrambling, and mapping the received signal in which the demodulated control signal is removed, by again demapping the received signal with QPSK, the data signal is demodulated.

Therefore, a control signal in which an HPR is allocated may be first separated from the received signal, and then data in which an LPR is allocated may be separated from the received signal. In this case, by repeatedly transmitting a control signal or by applying a low modulation order and code rate to control information, the transmitter can enhance a demodulation probability.

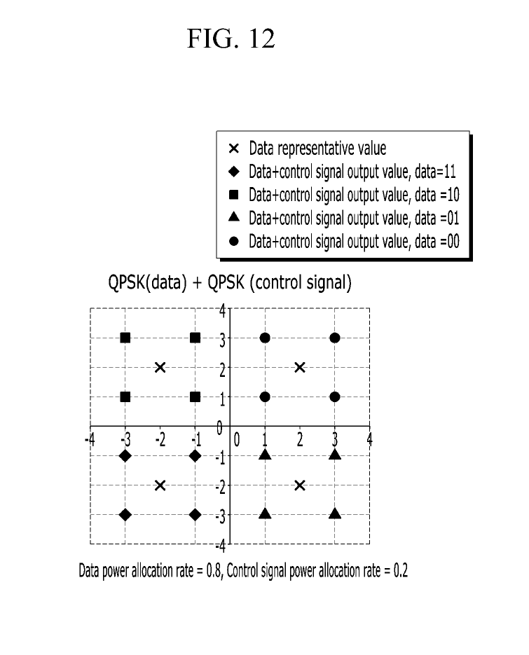

FIG. 12 is a diagram illustrating a constellation of a power allocation method in which an LPR is allocated to PR_{C} according to an exemplary embodiment of the present invention.

Referring to FIG. 12, a control signal and a data signal are modulated based on QPSK. Because an HPR of 0.8 is allocated to data and an LPR of 0.2 is allocated to control information, a data signal can be demodulated regardless of whether a control signal exists. The receiver applies and demodulates a modulation order of a data signal to input information. In this case, because an LPR is allocated to control information, a low modulation order and coding rate should be applied to modulation of control information, and a transmitter repeatedly transmits a control signal using much time and frequency resource, thereby enhancing demodulation performance of the control signal.

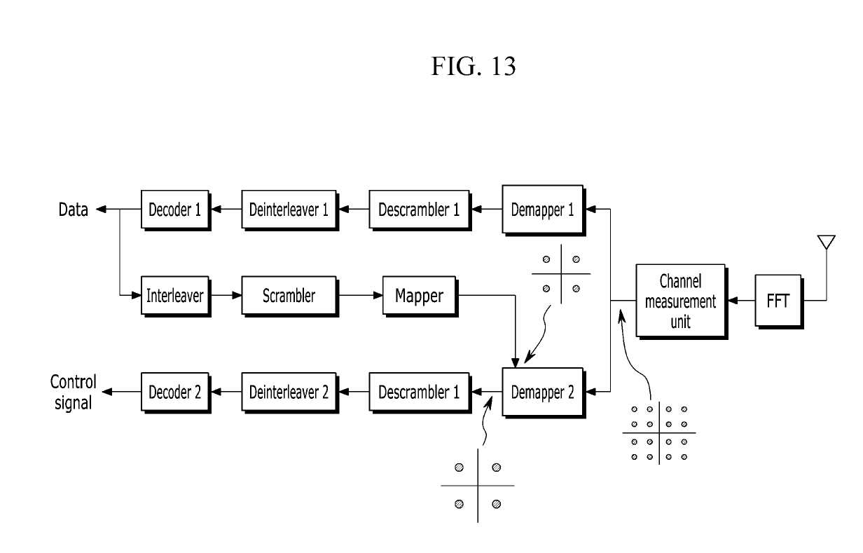

FIG. 13 is a diagram illustrating a receiving apparatus according to another exemplary embodiment of the present invention.

Referring to FIG. 13, a receiving terminal, having received a QPSK data signal and a QPSK control signal, demodulates data and removes the demodulated data from a received signal. Thereafter, after again interleaving, scrambling, and mapping the received signal in which the demodulated data is removed, by again demapping the received signal with QPSK, a control signal is demodulated.

In an exemplary embodiment of the present invention, a base station may notify a terminal whether an HPR was allocated to control information or whether an HPR was allocated to data.

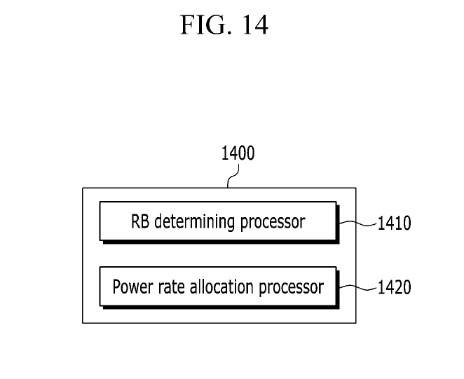

FIG. 14 is a diagram illustrating a resource allocation apparatus according to an exemplary embodiment of the present invention.

A resource allocation apparatus 1400 according to an exemplary embodiment of the present invention includes a resource block (RB) determining processor 1410 and a power rate allocation processor 1420. The resource allocation apparatus 1400 according to an exemplary embodiment of the present invention may transfer a determined RB and an allocated power rate to a transmitting apparatus.

The RB determining processor 1410 selects a resource allocation method according to quality of data, and control information determines at least one of a plurality of resource blocks that are expressed in a subframe to transmit to a terminal according to the selected resource allocation method. The resource allocation method of the RB determining processor 1410 will be described in detail hereinafter.

The power rate allocation processor 1420 may allocate an appropriate power rate to a control signal and a data signal. As described above, the power rate allocation processor 1420 allocates an HPR to a control signal or allocates an HPR to a data signal, as needed. When the HPR is allocated to the control signal, an LPR may be allocated to the data signal.

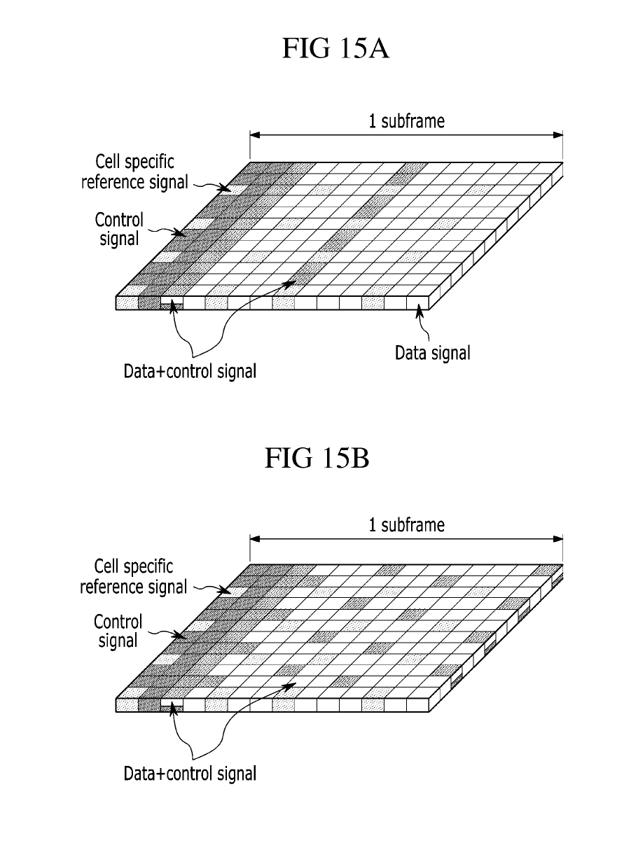

FIGS. 15A and 15B are diagrams illustrating a resource allocation method according to an exemplary embodiment of the present invention.

When transmitting a control signal and a data signal, a resource allocation method according to an exemplary embodiment of the present invention that is described with reference to FIGS. 15A and 15B uses a predetermined frequency resource and time resource. Therefore, a base station can transfer control information and minimize a resource loss at a necessary time.

In FIGS. 15A and 15B, an RB in which a cell reference signal is transmitted (hereinafter referred to as a “cell reference RB”), an RB in which a control signal is transmitted (hereinafter referred to as a “control signal RB”), an RB in which data is transmitted (hereinafter referred to as a “data RB”), and an RB in which data and a control signal are transmitted together (hereinafter referred to as an “data+control signal RB”) are illustrated.

Referring to FIG. 15A, a data signal and a control signal may be transmitted over an entire frequency resource at a specific time resource. In this case, at a specific time resource, a cell reference signal is not transmitted.

Referring to FIG. 15B, a data signal+control signal RB is located at a periphery of a cell reference RB. In this way, when a data+control signal RB is located at a periphery of the cell reference RB, it may help a terminal to grasp channel state information like a function of a cell reference signal.

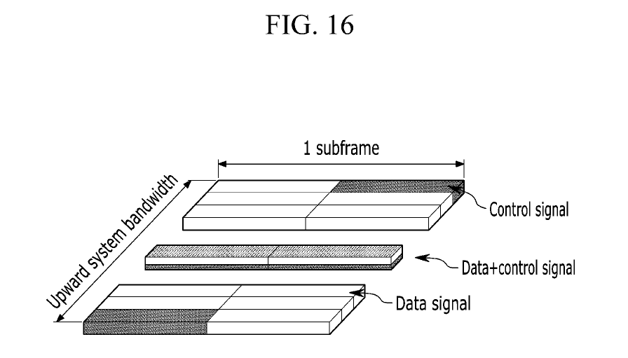

FIG. 16 is a diagram illustrating an uplink resource allocation method according to an exemplary embodiment of the present invention.

In FIG. 16, a control signal RB, a data RB, and a data+control signal RB are illustrated. A conventional control signal RB may be located at both ends of an uplink bandwidth, but according to an exemplary embodiment of the present invention, at a specific location of an uplink bandwidth, a data+control signal RB may be located. Because an uplink control signal according to an exemplary embodiment of the present invention can be transmitted together with data, an uplink resource can be efficiently used.

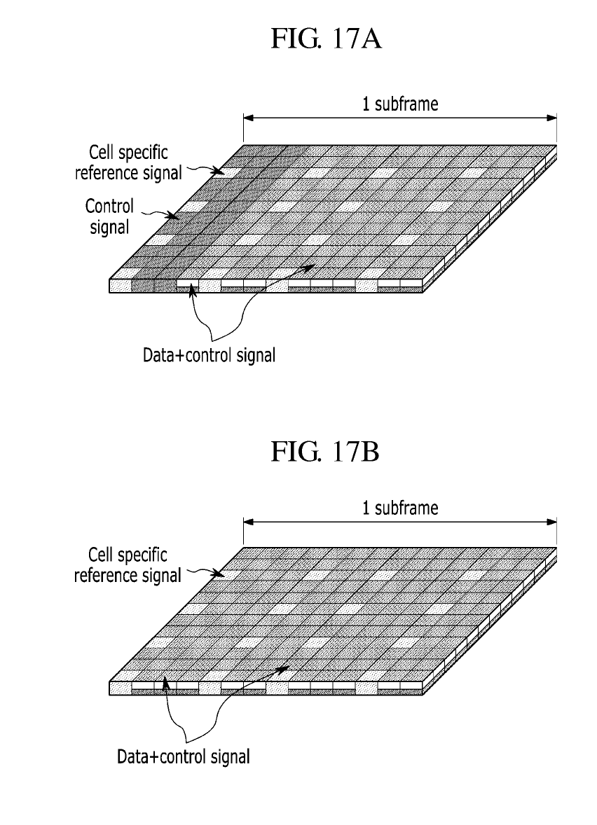

FIGS. 17A and 17B are diagrams illustrating a resource allocation method according to another exemplary embodiment of the present invention.

In FIGS. 17A and 17B, a cell reference RB, a control signal RB, and a data+control signal RB are illustrated. That is, in a resource allocation method according to another exemplary embodiment of the present invention that is described with reference to FIG. 16, all data is transmitted together with control information. When following this method, quality of a control signal can be enhanced and more control information can be transmitted, and thus when more terminals are connected to a base station, a resource allocation method can be effectively applied.

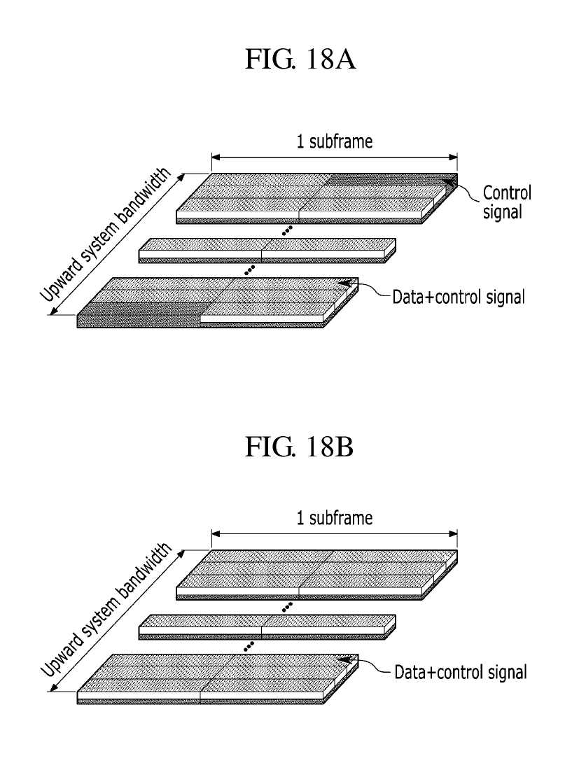

FIGS. 18A and 18B are diagrams illustrating an uplink resource allocation method according to another exemplary embodiment of the present invention.

In FIGS. 18A and 18B, a control signal RB and a data+control signal RB are illustrated. That is, in an uplink resource allocation method according to the current exemplary embodiment of the present invention that is described with reference to FIGS. 18A and 18B, all data is transmitted together with control information. In this case, a modulation method of a high modulation rate that is included within a range that can demodulate from QPSK may be applied to data, and a modulation method of a modulation rate of QPSK or less may be applied to a control signal.

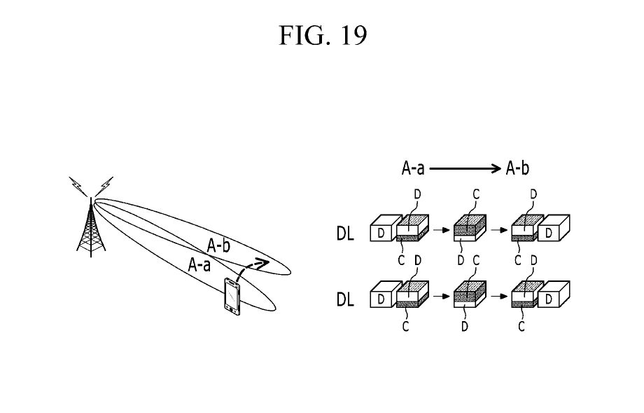

FIG. 19 is a diagram illustrating a resource allocation method of beam switching according to another exemplary embodiment of the present invention.

Referring to FIG. 19, when switching a beam transmitting from the inside of a cell of a base station to a terminal, a power rate that is allocated to a data signal and a control signal is adjusted according to a switching step. For example, when transmitting an A-abeam, a power rate ‘1’ is allocated (PR_{D}=1) to a data signal, and when beam switching is determined, a data signal and a control signal are simultaneously transmitted to one downlink resource. In this case, a power rate that is allocated to a data signal is larger than a power rate that is allocated to a control signal (PR_{D}>PR_{C}). Thereafter, while switching a beam, a larger power rate is allocated to a control signal (PR_{C}>PR_{D}). Thereafter, a power rate that is again allocated to a data signal increases larger than a power rate that is allocated to a control signal (PR_{D}>PR_{C}), and a power rate ‘1’ is finally again allocated to the data signal (PR_{D}=1). That is, entire transmission power of a transmitting apparatus can be used for transmitting a data signal.

A resource allocation method of beam switching according to the current exemplary embodiment of the present invention may be applied even to a case of handover in which a terminal changes a base station.

As described above, according to an exemplary embodiment of the present invention, a control signal and a data signal can be simultaneously transmitted to a terminal with a method of differently allocating a power rate to each of the control signal and the data signal. Therefore, even when control information to transmit to a terminal rapidly increases, by sharing a resource that is allocated to a data signal, a base station can transmit a control signal and thus a resource can be efficiently used.

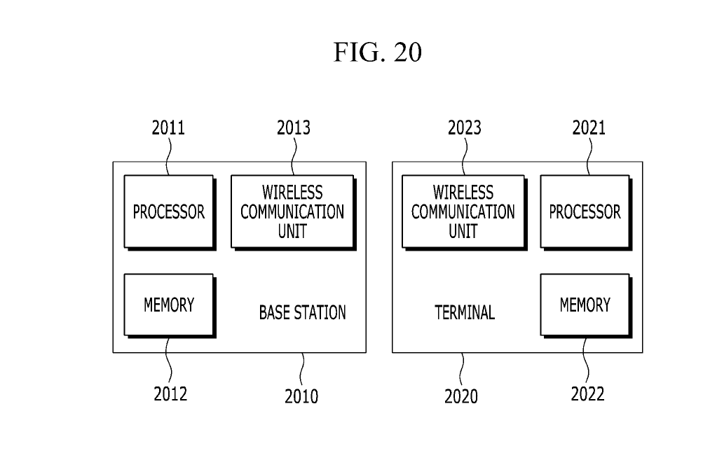

FIG. 20 is a block diagram illustrating a wireless communication system according to another exemplary embodiment of the present invention.

Referring to FIG. 20, the wireless communication system according to the exemplary embodiment of the present invention includes a base station 2010 and a terminal 2020.

The base station 2010 includes a processor 2011, a memory 2012, and a radio frequency (RF) unit 2013. The memory 2012 is connected with the processor 2011 to store various information for driving the processor 2011. The RF unit 2013 is connected with the processor 2011 to transmit and/or receive a radio signal. The processor 2011 may implement a function, a process, and/or a method which are proposed in the present invention. In this case, in the wireless communication system according to the exemplary embodiment of the present invention, a radio interface protocol layer may be implemented by the processor 2011. An operation of the base station 2010 according to the exemplary embodiment of the present invention may be implemented by the processor 2011.

The terminal 2020 includes a processor 2021, a memory 2022, and an RF unit 2023. The memory 2022 is connected with the processor 2021 to store various information for driving the processor 2021. The RF unit 2023 is connected with the processor 2021 to transmit and/or receive the radio signal. The processor 2021 may implement a function, a process, and/or a method which are proposed in the present invention. In this case, in the wireless communication system according to the exemplary embodiment of the present invention, the radio interface protocol layer may be implemented by the processor 2021. An operation of the terminal 2020 according to the exemplary embodiment of the present invention may be implemented by the processor 2021.

In the exemplary embodiment of the present invention, the memory may be positioned inside or outside the processor, and the memory may be connected with the processor through various already known means. The memory is various types of volatile or non-volatile storage media, and the memory may include, for example, a read-only memory (ROM) or a random access memory (RAM).

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A method of transmitting a signal to a terminal, the method comprising:
determining at least one of a plurality of resource blocks (RBs) of a frequency resource and a time resource in a subframe that transmits to the terminal;
allocating a power rate to each of a first signal and a second signal to transmit to the terminal; and
transmitting the first signal and the second signal through the RB according to the power rate.

2. The method of claim 1, wherein the first signal and the second signal are signals comprising different kinds of information, and the first signal is a control signal comprising control information about the terminal.

3. The method of claim 1, wherein the first signal and the second signal are signals comprising different kinds of information, and the first signal is a data signal comprising data to transmit to the terminal.

4. The method of claim 1, wherein the first signal is a control signal comprising control information about the terminal, and the second signal is a data signal comprising data to transmit to the terminal.

5. The method of claim 1, wherein the determining of at least one comprises determining an RB that is located at a time at which an RB in which a cell reference signal is transmitted does not exist.

6. The method of claim 1, wherein the determining of at least one comprises determining an RB that is located at a periphery of an RB in which a cell reference signal is transmitted.

7. The method of claim 1, wherein the determining of at least one comprises determining an RB in which data is transmitted.

8. The method of claim 1, wherein the allocating comprises allocating a high power rate (HPR) to the first signal and allocating a low power rate (LPR) to the second signal.

9. The method of claim 1, wherein the transmitting of the first signal comprises modulating each of the first signal and the second signal to correspond to a modulation order.

10. The method of claim 9, wherein the modulating of each of the first signal comprises modulating each of the first signal and the second signal to correspond to the modulation order according to a quadrature phase shift keying (QPSK) method or a quadrature amplitude modulation method.

11. An apparatus that transmits a signal to a terminal, the apparatus comprising:
a resource block (RB) determining processor that determines at least one of a plurality of RBs of a frequency resource and a time resource in a subframe that transmits to the terminal;
a power rate allocation processor that allocates a power rate to each of a first signal and a second signal to transmit to the terminal; and
a transmitter that transmits the first signal and the second signal through the RB according to the power rate.

12. The apparatus of claim 11, wherein the first signal and the second signal are signals comprising different kinds of information, and the first signal is a control signal comprising control information about the terminal.

13. The apparatus of claim 11, wherein the first signal and the second signal are signals comprising different kinds of information, and the first signal is a data signal comprising data to transmit to the terminal.

14. The apparatus of claim 11, wherein the first signal is a control signal comprising control information about the terminal, and the second signal is a data signal comprising data to transmit to the terminal.

15. The apparatus of claim 11, wherein the RB determining processor determines an RB at a time at which an RB in which a cell reference signal is transmitted does not exist.

16. The apparatus of claim 11, wherein the RB determining processor determines an RB that is located at a periphery of an RB in which a cell reference signal is transmitted.

17. The apparatus of claim 11, wherein the RB determining processor determines an RB in which data is transmitted.

18. The apparatus of claim 11, wherein the power rate allocation processor allocates a high power rate (HPR) to the first signal and allocates a low power rate (LPR) to the second signal.

19. The apparatus of claim 11, wherein the transmitter modulates each of the first signal and the second signal to correspond to a modulation order.

20. The apparatus of claim 19, wherein the transmitter modulates each of the first signal and the second signal to correspond to the modulation order according to a quadrature phase shift keying (QPSK) method or a quadrature amplitude modulation method.
